(19) United States
(12) Patent Application Publication
(10) Pub. No.: US 2026/0014717 A1
(43) Pub. Date: Jan. 15, 2026

(54) CUTTING SET WITH HAIR TRANSPORT ELEMENT

(71) Applicant: WAHL GMBH, St. Georgen (DE)

(72) Inventor: Roberto KRAUSE, Villingen (DE)

(21) Appl. No.: 19/265,533

(22) Filed: Jul. 10, 2025

(30) Foreign Application Priority Data
Jul. 12, 2024 (DE) 10 2024 119 933.4

(51) Int. Cl. B26B 19/38; B26B 19/04; B26B 19/06

(52) U.S. Cl. CPC B26B 19/3813; B26B 19/046; B26B 19/06; B26B 19/3846

(57) ABSTRACT

A cutting set for a hair clipper includes a first cutting blade, a second cutting blade movable relative to the first cutting blade, the second cutting blade is designed to be movable both laterally and forwards and backwards relative to the first cutting blade, and a hair transport element which is arranged on the opposite side of the second movable cutting blade with respect to the first cutting blade and moves with the latter, the hair transport element has a first row of steps arranged next to one another which extend parallel to the first or second cutting blade, so that during the lateral movement of the second movable cutting blade, the hair clippings are transported away to the side of the cutting blades, the hair transport element has a second row of steps arranged next to one another, which second row is arranged parallel to the first row.

### BACKGROUND

The present invention relates to a cutting set for a hair clipper with a hair transport element for removing hair clippings after cutting.

### PRIOR ART

When cutting hair with a hair clipper, the well-known cutting sets for hair clippers, depending on the cutting position, lead to an accumulation of hair clippings on the hair clipper. This accumulation of hair clippings blocks the view of the cutting region and also impairs the supply of uncut hair. The hairdresser must therefore tilt the machine to the side after each accumulation of hair or shake the hair off the cutting set of the machine. This is especially annoying when a final haircut is required.

To solve this problem, EP 3 117 972 A1 proposes a hair clipper with a cutting set which consists of at least one fixed or adjustable shearing blade and a shearing blade which can be driven in an oscillating manner in the transverse direction substantially parallel to the front edge of the shearing blade, and which has a hair transport element which has transport teeth which are arranged substantially along and spaced from the cutting edge of the shearing blade, wherein the shearing blade is arranged between the shearing blade and the hair transport element and wherein the cutting edge of the shearing blade projects beyond the front edge of the hair transport element. Although this cutting set basically solves the problem of transporting away the hair clippings from the cutting blades, very fine hair clippings can slip further behind the hair transport element when the blade is oscillating. This problem is aggravated when a length adjustment device is present that allows the oscillating blade to be moved forward and backward to adjust a cutting length. If the cutting blade is positioned far forward, a space can be created behind the hair transport element where the hair transport element can no longer transport the hair clippings, especially smaller hair snippets.

### SUMMARY

The object of the invention is to provide a possibility to transport also hair clippings that cannot be reached by a conventional hair transport element.

A cutting set for a hair clipper according to the invention comprises a first cutting blade, a second cutting blade movable relative to the first cutting blade, wherein the second cutting blade is designed to be movable both laterally and forwards and backwards relative to the first cutting element; and a hair transport element which is arranged on the opposite side of the second cutting blade with respect to the first cutting blade and moves with the latter, wherein the hair transport element has a first row of adjacent steps (or teeth) extending parallel to the first or second cutting blade, so that upon lateral movement of the second cutting blade the hair is transported away from the steps to the side of the cutting combs, wherein the hair transport element has a second row of adjacent steps arranged parallel to the first row. The second row of steps extends the hair transport element backwards so that even when the movable cutting blade is pushed far forwards, the hair clippings are transported to the sides of the cutting set.

In particular, the first row of steps is directed forwards and the second row of steps is rotated about the parallel axis with respect to the first row of steps, preferably by at least 45°, 60°, 70° or 90°. A rotated second row of steps allows the hair clippings that get behind the movable cutting blade to be better captured by the steps. The steps are preferably of the same shape, but can also have different step shapes and/or different step spacing.

The second row of steps is also preferably directed upwards, in the opposite direction relative to the support surface of the cutting set. This ensures that the hair that has fallen behind the first row of steps is removed.

The first row of steps preferably protrudes upwards beyond the second row of steps. This removes the majority of the hair clipping from the first row of steps.

The first row of steps may have steps that are mainly directed towards the cutting combs, especially also upwards. This means that the hair clippings immediately reach the hair transport element after cutting.

The hair transport element is preferably formed on a transmission element for the drive movement of the drive of a hair clipper. This allows the hair transport element to be designed in a compact manner.

The first row of steps is preferably flat on the side opposite the cutting edges of the cutting combs. This ensures that the second row of steps can be positioned directly next to the first row of steps and that there are no obstructions above the second row of steps.

The steps of the first and/or second row of steps have an increasing cross-section, particularly in the lateral direction (outwards). This makes it easier to eject the hair clippings from the individual steps.

Preferably, the steps of the second row are formed in a groove, in particular in a groove of a transmission element. Furthermore, the steps preferably do not extend beyond the edge of the groove. This ensures that the second row of steps on the cutting set can be pushed under the housing of the hair clipper.

The steps of the second row are inclined on the side facing away from the first row of steps. This allows the steps to be enlarged

Preferably, a particularly symmetrical partition wall or partition step is provided in the middle of the first and/or second row of steps. The partition wall is preferably designed as a vertical plate. With this clear partition wall or partition step, the hair clippings are better transported to the side that is closer to the edge of the cutting set. The partition wall can extend beyond the other steps in the first row to provide even better separation.

Preferably, the hair transport element has fixing hooks with which it can be fastened to the second cutting blade.

### BRIEF DESCRIPTION OF THE DRAWINGS

FIG. 1 shows an isometric view of a hair clipper with a hair transport element according to the invention;

FIG. 2 shows an isometric exploded view of the hair clipper of FIG. 1;

FIG. 3 shows the exploded view from FIG. 2 in a side view;

FIG. 4 shows an isometric view of the hair transport element according to the invention;

FIG. 5 shows the hair transport element from FIG. 4 in a plan view;

FIG. 6 shows the hair transport element from FIG. 4 in a side view;

FIG. 7 shows a side view of the hair clipper with the movable cutting blade retracted; and

FIG. 8 shows a side view of the hair clipper with the movable cutting blade advanced.

### DETAILED DESCRIPTION

FIG. 1 shows a hair clipper 100 in an isometric view. The hair clipper 100 comprises a main body housing 102 in which a motor 104 is arranged. A cutting set 50 is provided at the upper end of the main body housing 102. The cutting set 50 comprises a stationary cutting blade 52 and a movable cutting blade 54, wherein the movable cutting blade 54 can be moved forwards and backwards via an adjustment lever 106. The motor 104 drives a transmission element which is set into an oscillating movement via a mechanism and transmits this movement to the movable cutting blade 54.

In the preferred embodiment shown, the hair transport element 10 is formed on the transmission element 60 so that the lateral movement can be transmitted directly to the hair transport element 10. However, it is also conceivable that the hair transport element 10 is fastened directly to the movable cutting blade 54.

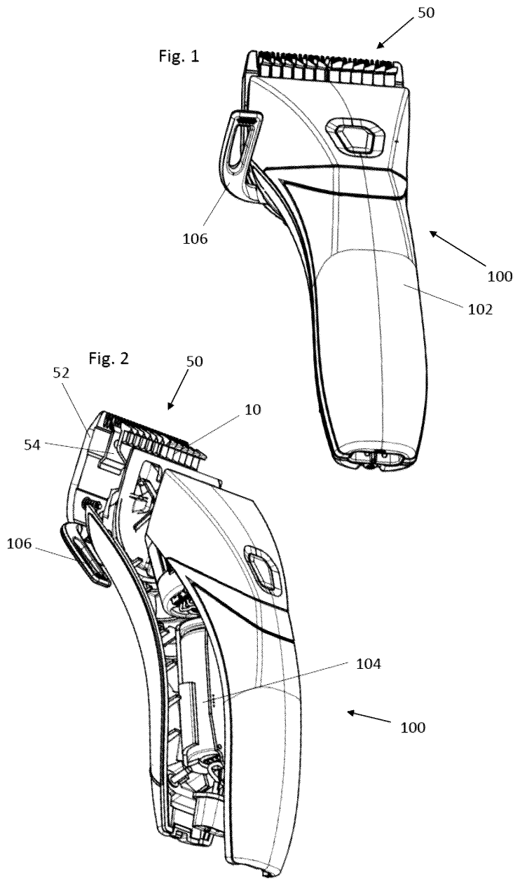

FIG. 2 shows an isometric view of the hair clipper in an exploded view. Here the motor 104, the cutting set 50 with the cutting blades 52, 54 and the hair transport element 10 can be seen better.

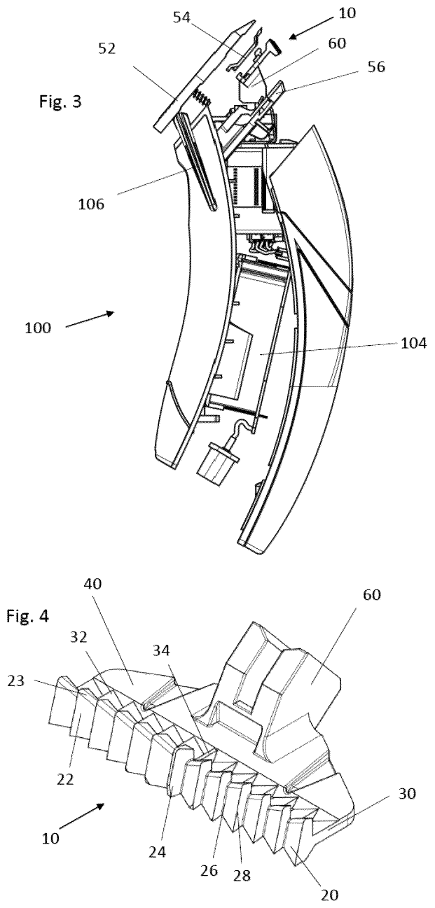

FIG. 3 shows a side view of the exploded view from FIG. 2. Here the arrangement of the individual elements can be clearly seen. The stationary cutting blade 52 is arranged at the upper end, below and directly adjacent to it is the movable cutting blade 54. The hair transport element 10 and the transmission element 60, which are formed together in the embodiment shown, are then located on the movable cutting blade 54. The stationary cutting blade 52 is then attached to the main body of the hair clipper via a cutting set carrier 56 and thus holds the movable cutting blade 54, the transmission element 60 and the hair transport element 10 between itself and the upper end of the main body of the hair transport element 10.

The hair transport element 10 is formed between the cutting blades 52, 54 of the cutting set 50 and the main body, which is received by the main body housing 102. The hair transport element 10 shown in FIG. 4 is formed on the transmission element 60 and has a first row of steps or steps 20 which is formed from a plurality of steps or teeth 22 arranged next to one another.

When the hair transport element 10 is installed in the hair cutting device 10, the steps are aligned forward in the direction of the cutting blade so that the hair clippings can directly hit the steps 22 and be transported away. Preferably, each step can comprise a step element 23 directed towards the top and lateral with respect to the step 22, so that hair clippings above the hair transport element 10 can also be grasped. On the rear side, the first row of steps drops in particular vertically in order to be able to be pulled as close as possible to the housing in a retracted position of the movable cutting blade 54.

The steps 22 have an inclined surface so that the cross-section of an individual step 22 increases from the step base 26, with which it rests against a previous step 22, to the step edge 28.

In the middle of the first row of steps 20 there is a partition wall 24 which can be higher but is preferably flush with the other steps in a side view. On both sides of the partition wall, the steps are preferably formed in opposite directions. The partition wall 24 is not a step, is sloping downwards on both sides and in particular does not have an increasing cross-section. The partition wall 24 is preferably at least 0.5 mm, more preferably 1 mm or two mm thick and less thick than a step 22.

With respect to the cutting edge of the movable cutting blade 54, a second row of steps 30 is arranged behind the first row of steps 20. The second row of steps 30 is preferably formed in a plate-shaped base 40 and, analogously to the first row of steps, can have a central partition wall 34 and a plurality of steps 32 which, depending on the side, point in opposite directions with respect to the partition wall 34.

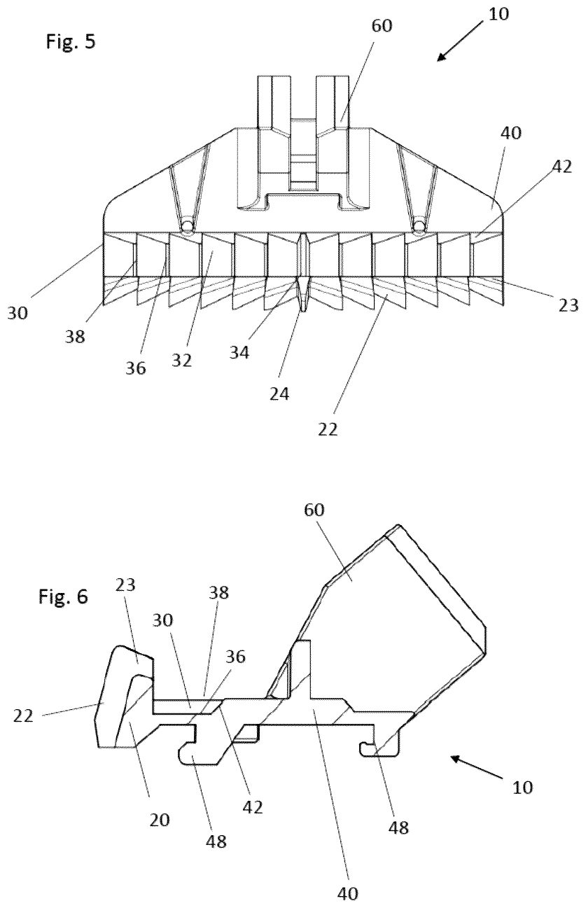

FIG. 5 shows the hair transport element 10 in a plan view. Here one can clearly see how the steps 22 and 32 increase in size. In particular, in the second row of steps, the step edges 38 are wider than the step base 36, in that the groove wall 42 of the second row of steps 30 is inclined.

FIG. 6 shows the hair transport element 10 in a side view. On the side of the hair transport element 10 opposite the rows of steps, fastening hooks 48 are formed, with the aid of which the hair transport element 10 can be fastened to the movable cutting blade 54. The first row of steps 20 is slightly inclined backwards here, in particular by 5° to 20° degrees. Furthermore, the preferred vertical design can be seen on the back of row of steps 20. The second row of steps 30 preferably adjoins the first row of steps directly.

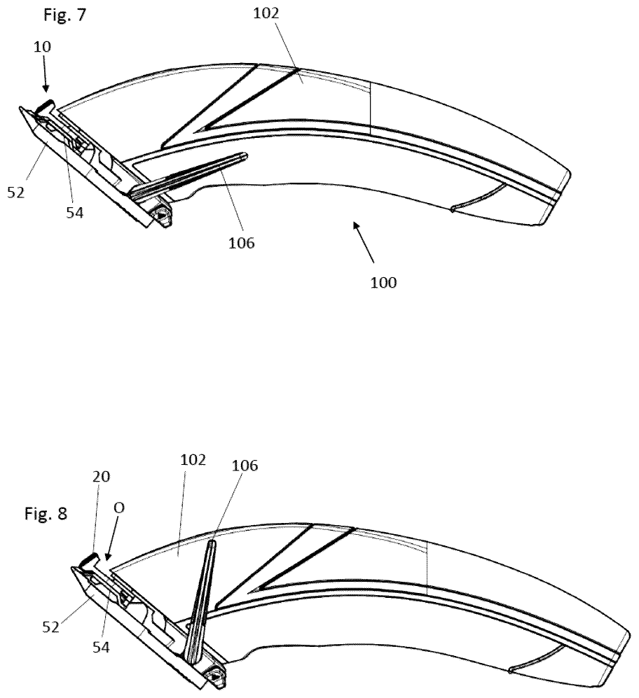

FIGS. 7 and 8 show the hair clipper 100 in a side view with a movable cutting blade 54 advanced and retracted. In FIG. 7, the adjustment lever 106 is rotated backwards. As a result, the movable cutting blade 54 and thus also the hair transport element 10 are also pulled backwards. In the preferred embodiment in which the second row of steps is formed in a groove in the plate-shaped base 40 so that the second row does not protrude beyond the base 40, the hair transport element 10 can thereby be pulled backwards to the back of the first row of steps. In this position, the second row of steps 30 is mostly located under the housing and the gap behind the first row of steps 20 is very small. As a result, the first row of steps 20 is already essentially sufficient to transport the hair clippings to the side of the cutting blades 52, 54.

In FIG. 8, the adjusting lever is turned forward so that the movable cutting blade 54 is also in a far advanced position. It can be clearly seen here that in this position of the movable cutting blade 54 behind the first row of steps 20, a distance O is created between the rear side of the first row of steps 20 and the housing 102, in which distance hair clippings can accumulate. This is because the first row of steps can no longer transport the hair away.

While a particular embodiment of the present cutting set with hair transport element has been described herein, it will be appreciated by those skilled in the art that changes and modifications may be made thereto without departing from the invention in its broader aspects and as set forth in the following claims.

### REFERENCE NUMERALS

10 hair transport element
20 first row of steps
22 step
23 side step element
24 partition wall
26 step base
28 step edge
30 second row of steps
32 step
34 partition wall
36 step base
38 step edge
40 plate-shaped base
42 groove wall
48 fastening hooks
50 cutting set
52 stationary cutting blade
54 movable cutting blade
56 cutting set carrier
60 transmission element
100 hair clipper
102 main body housing
104 motor
106 adjustment lever
O distance

1. A cutting set for a hair clipper, comprising:
a first cutting blade;
a second cutting blade movable relative to the first cutting blade, wherein the second cutting blade is designed to be movable both laterally and forwards and backwards relative to the first cutting blade; and
a hair transport element which is arranged on the opposite side of the second movable cutting blade with respect to the first cutting blade and moves with the latter; the hair transport element has a first row of steps with steps arranged next to one another which extend parallel to the first or second cutting blade, so that during the lateral movement of the second movable cutting blade the hair clippings are transported away to the side of the cutting blades; and
the hair transport element has a second row of steps with steps arranged next to one another, which second row is arranged parallel to the first row.

2. The cutting set according to claim 1, wherein the first row of steps is oriented forward and the second row of steps is oriented upward.

3. The cutting set according to claim 1, wherein the first row of steps protrudes upwards beyond the second row of steps.

4. The cutting set according to claim 1, wherein the hair transport element is formed on the transmission element for transmitting the drive movement of the drive to the movable cutting blade.

5. The cutting set according to claim 1, in which the first row of steps is designed to slope vertically downwards on the side opposite the cutting edges of the cutting blades.

6. The cutting set according to claim 1, wherein the steps of the first and/or second row of steps have an increasing cross-section.

7. The cutting set according to claim 1, in which the steps of the second row of steps are formed in a groove and in particular do not protrude beyond the groove edge.

8. The cutting set according to claim 7, wherein the groove wall is inclined on the side directed away from the first row of steps.

9. The cutting set according to claim 1, in which a partition wall is provided centrally in the first and/or second row of steps.

10. The cutting set according to claim 1, wherein the hair transport element has fastening hooks with which the hair transport element can be fastened to the movable cutting blade.
